(19) United States
(12) Patent Application Publication
(10) Pub. No.: US 2016/0183516 A1
(43) Pub. Date: Jun. 30, 2016

(54) Scent Mine

(71) Applicant: Vincent D. Wilson, Newland, NC (US)

(72) Inventor: Vincent D. Wilson, Newland, NC (US)

(21) Appl. No.: 14/813,370

(22) Filed: Jul. 30, 2015

Related U.S. Application Data
(60) Provisional application No. 61/999,527, filed on Jul. 30, 2014.

(51) Int. Cl. A01M 31/00

(52) U.S. Cl. CPC A01M 31/008

(57) ABSTRACT

The company 1-SHOT has designed the following invention to be a biodegradable multi-purpose product used in the outdoor industry for attracting animals.

“The Scent Mine is a two piece assembly made from organic material that will decompose over time and return to the soil. There is a top component that has the appearance of a land mine with a flat top that has a hole in the center for air flow. The sides arc angled and approximately 1 inch in length. At the bottom on the inside edge there is a step designed to hold the bottom component. The second component is a flat round disc that is pressed into the bottom of the shell and rests on the inside step. The diameter differences between the two components create a friction fit that holds the assembly together. When used as an animal attractant a small amount of native soil is placed between the two components to assist in creating a natural smell. Once the soil is in place the two components can be pressed together to form the complete assembly. The user then places the unit in an area where their animal of interest is found. If the “The Scent Mine” purchased is pre-scented then the user can just set it on the ground and wait for the animal to arrive. If the unit purchased is un-scented then the user can add any odor, scent or attractant to “The Scent Mine” because the material will absorb it and start dispersing the odor through the top hole and semi-permeable material.

### BACKGROUND OF THE INVENTION

The concept of this invention was motivated by the need to improve upon current scent products that fail to do the following; inadequately dispense scent for hunting purposes, once the container or device is empty become litter that must be removed from the area, and while being returned the empty container or device contaminates clothing, backpacks, hands, vehicles, basically anything it comes into contact with as it is transported back to be properly disposed. While using products currently sold for scent distributing methods, many deficiencies in their design were discovered. As a result, the invention “The Scent Mine” was developed to overcome these issues. A product was needed that could, eliminate error, reduce foreign scent, have multiple uses, could be left in the woods without creating litter and thus avoid contaminating the users clothing or equipment as it is transported out of the woods for disposal. With a simple design “The Scent Mine” eliminates the possibility of error; there are no moving parts, no electrical components or multiple parts to assembly. Only two parts comprise “The Scent Mine's” assembly. Made from natural organic material “The Scent Mine” virtually eliminates odor that is produced from non-natural materials. The Scent Mine's versatility for multiple uses allows the customer the ability to use it in an unscented state, which gives them the opportunity to apply a scent of their choice. Or they can use the pre-scented model without the hassle of buying additional scent, or the mess and odor associated with dispensing. The ability to be left in the woods without removing was developed by using an organic material that will degrade naturally over time, thus making this product environmentally safe. In addition to these characteristics, the ability to use dirt from the exact area of “The Scent Mines” location for use adds a realistic smell that will be more attractive to animals and reduces the risk of spooking them. Optimal scent placement (applying scent directly from the original container to the scent object) was needed due to its inherent superiority in regards to effectiveness when compared to non-optimal scent placement (applying scent to a secondary object that transfers it to the scent object). In addition The Scent Mine also has the ability to be scented with any type of scent, lure, fragrance or attractant available, thus eliminating the need to purchase or carry any type of additional scent. The above reasons are why the invention “The Scent Mine” was developed.

### BRIEF SUMMARY OF INVENTION

The invention “The Scent Mine” is a multi-purpose product directed at the deer hunting market with specific focus on environmental safety through organic design that allows the unit to decompose without creating litter, scent application, pre-scented or unscented models. This product is designed to allow the user the ability to saturate it with their choice of scent or purchase a pre-scented model without having to purchase additional scents. It also allows them the ability to use the native soil to help create a sre natural scent with a simple design and assembly.
A. Use of earth from hunting location for a more realistic smell.
B. Un-scented or Pre-Scented models.
C. Bio-degradable design that utilizes organic material that will naturally decompose.

### BRIEF DESCRIPTION OF DRAWINGS

The following information is a brief summary that describes three pages of drawings.

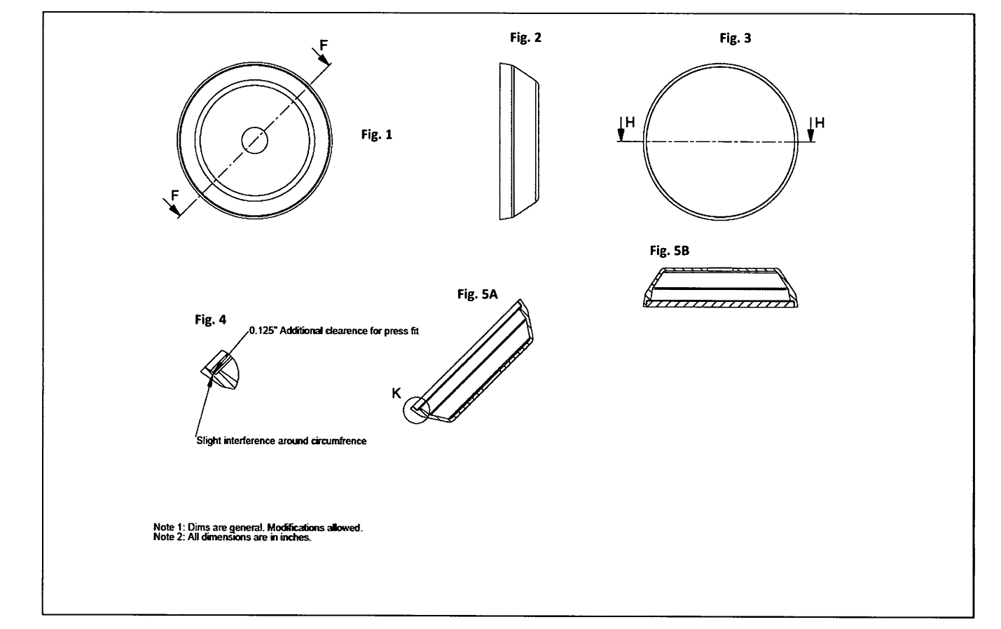

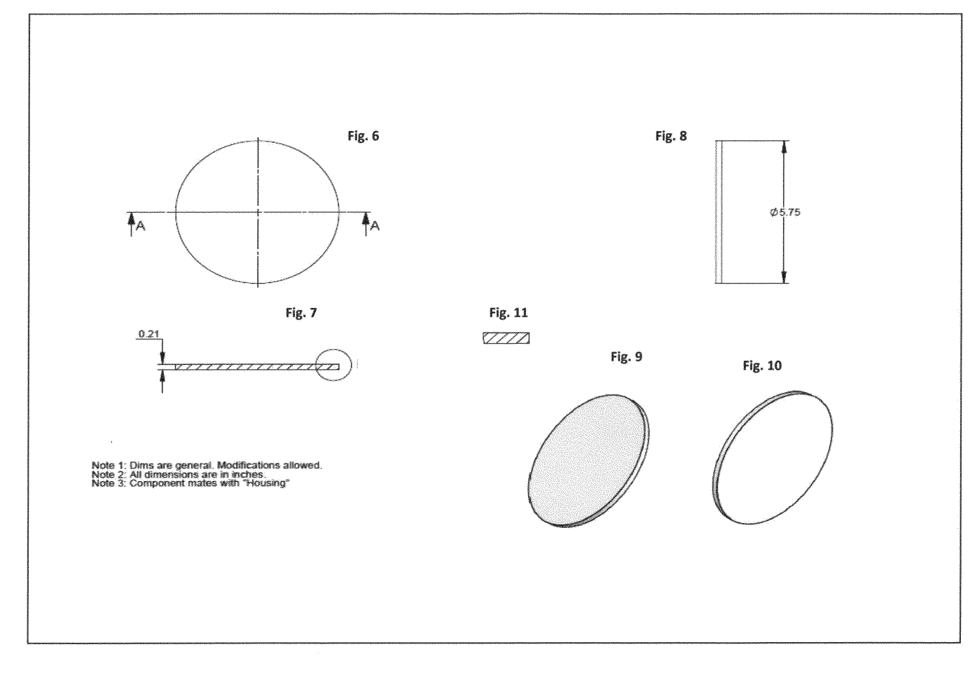

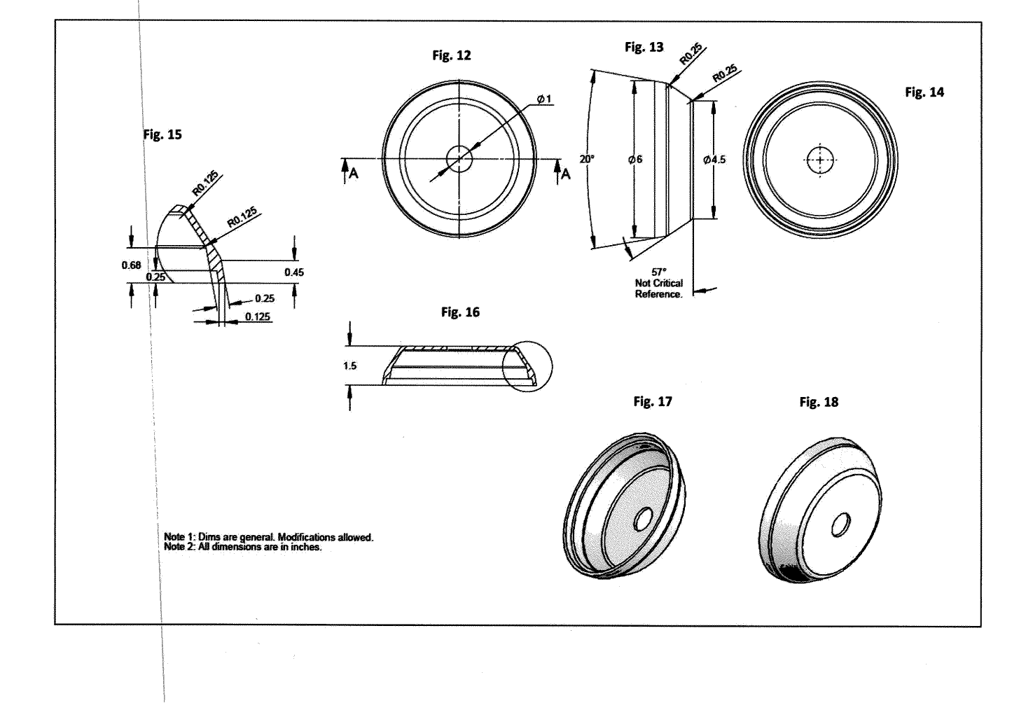

On page 1 there are six views; FIG. 1 which represents the top view, FIG. 2 the right side, FIG. 3 is the bottom view with assembled plate, FIG. 4 is a cross section of the wall including a view of the inside step shown with assembled interference fit, FIG. 5A shows a three dimensional rendering that includes one angled view and FIG. 5B the front assembled view.

On page 2 the bottom plate is shown with six views; FIG. 1 is the top view, FIG. 2 a front cross section view to display the plate thickness, FIG. 3 is the side view, FIG. 4 one top view, FIG. 5 one bottom view, and FIG. 6 showing an exploded view of FIG. 2.

On page 3 the completed assembly is shown with seven views, FIG. 1 a top view, FIG. 2 a side view, FIG. 3 a bottom view, FIG. 4 exploded view with a cross-section of the inside step where the interference fit occurs, FIG. 5 a front view, FIG. 6 an angled view of the inside, and FIG. 7 an angled view of the side top.

### DETAILED DESCRIPTION OUTLINE

I. Invention Description

a. Shell

b. Plate

c. Assembly

d. Orientation
II. Invention Use

a. As an attractant

b. Determining distance

c. Hunter safety, “Presence”

### DETAILED DESCRIPTION OF INVENTION

The following information is provided as a detailed description of the invention, The Scent Mine, formerly referred to as Wilson's Scent Mine in the Provisional Patent for Application. This invention is multi-purpose and can be used in the hunting industry or as an unscented or pre-scented product, but, is not limited to either market segments. Both uses will be explained in detail, while the assembly process is identical for both.

There are two (2) main components of the “The Scent Mine”; a shell and a plate. The first component is the shell; it is designed with a thin walled three (3) sided configuration that is round in geometry. The dimensions of the shell are as follows: 6.00″ inch outside diameter for the bottom of the shell, the top outside diameter of the shell is 4.75″ inches, see PG 1. The angle formed to connect the smaller top outside diameter with the larger bottom outside diameter is 57 degrees, see PG 1. This angle stops at the junction of the larger 6.00″ bottom diameter but a 20 degree angle begins here and ends at the bottom of the shell wall, with a length of 0.68″ see PG 1. The wall thickness is 0.125″ from the shell top down to the junction of the 6.00″ bottom diameter, then the wall thickness increases to 0.250″ inches. From the side with the shell resting on the bottom plate the overall height is 1.50″. The top of the shell is flat with a 1.00″ inch hole in the center. Looking at the side view of this invention it has the appearance of a military land mine. On the top flat there is a small diameter hole that is used to put seeds or other material into or on the surface of the assembly and to allow air flow out.

The second component, the plate, is a simple round flat solid disc designed to create a bottom in the open shell. The dimensions for the plate are as follows; the outside diameter is 5.75″ inches and the thickness is 0.210″ inches, see PG 2. The plate presses into the bottom portion of the shell.

These two components mate together to form an assembly, see PG 3. The shell houses the plate which is press fitted into the bottom of the shell and rests against a step that is designed into the shell at 0.250″ from the bottom edge, see PG 3. The plate is pressed into the shell until it makes contact with the step and is held together by friction from the inside diameter of the shell and the outside diameter of the plate. The friction fit is created by designing the diameter on the plate at 5.75″ to press against the inner wall inside diameter on the housing that is 0.125″ thick. The 20 degree lead in angle of the shell allows the plate to be wedged into the side walls. To allow the plate to get started the lowest edge of the shell is designed to be slightly larger than the plate, 6.00″.

Once assembled the correct orientation for use is to position the assembly with the hole on top of the shell up, see PG 3, which positions the plate as the bottom or base. There are at a multiple uses that the “The Scent Mine” can perform. First, for hunting purposes, the bottom plate can be left unassembled if just using scent or lure. Once “The Scent Mine” is in position it can be used as an attractant for the hunting industry by pouring or squirting the desired scent or lure on top of the shell, around and inside the small hole at the top. Once the scent or lure is applied the user can either leave “The Scent Mine in the location selected to attract the specific animal or move it to a more desired location. The Scent Mine's designed air flow is out of the top hole helping to disperse the scent or lure used. The organic eco friendly material used to make the “The Scent Mine” allows the user to leave it without having to remove it from its location. It will simply decompose naturally over time.

The company claim is that our invention is:

1. Any product of organic, biodegradable, recycled, synthetic, natural or manmade material that will decompose naturally over time and eliminate litter or adverse reaction to the environment. It will also allow the user the ability to leave it without having to retrieve the product thus eliminating the transfer of adverse odors from the product to their back pack or clothes.
a. A top component that is shaped like a land mine has a flat top with a hole in the center for air flow, sloped sides that angle out to form a diameter. On the inside of the bottom edge of the angled side is a step designed to allow the bottom assembly to be pressed into the top piece, (shell).
b. A flat component that forms the bottom of the assembly. This component is slightly larger than the top components diameter and when pressed in is held in place by friction from the interference fit between the two components.

2. The product of claim 1:
Is designed to both absorb liquids and then disperse them over time through the top hole and semi-permeable material, or to be pre-scented with any type of odor, scent, lure, attractant or any similar substance with the intent of attracting animals.

3. The product of claim 1:
Is produced with organic material that is designed to decompose or degrade over time and return to the soil. This is a tremendous improvement over current products that are made of materials which require the user to retrieve and remove them from the hunting location where the product was used and return them to a local landfill for proper disposal. This is necessary in order for the user to avoid litter and adverse odor contamination.
